(19) United States
(12) Patent Application Publication
(10) Pub. No.: US 2026/0217058 A1
(43) Pub. Date: Jul. 30, 2026

(54) TIRE WITH INTERNAL AIR CHAMBERS

(71) Applicants: Jorge Saez, Miami, FL (US); Lazaro Saez, Miami, FL (US)

(72) Inventors: Jorge Saez, Miami, FL (US); Lazaro Saez, Miami, FL (US)

(21) Appl. No.: 18/728,623

(22) PCT Filed: May 15, 2024
(86) PCT No.: PCT/US2024/029490

§ 371 Date: Jul. 12, 2024

Related U.S. Application Data
(60) Provisional application No. 63/466,515, filed on May 15, 2023.

(51) Int. Cl. B60C 5/24; B60C 5/22; B60C 17/01

(52) U.S. Cl. CPC B60C 5/24; B60C 5/22; B60C 17/01

(57) ABSTRACT

A tire comprising an inner cavity structure and a plurality of independent air chambers defining the inner cavity structure. Each air chamber is isolated from the other air chambers by internal walls within the inner cavity structure. The internal walls delineate and define the boundaries of the air chambers, extending radially from a center of the tire, traversing along the tire circumference, or inclined at predetermined angles. The plurality of independent air chambers can be pre-inflated with air or nitrogen. A thickness of the internal walls is optimized for balancing structural integrity and weight. The air chambers may be arranged in concentric layers from an inner circumference to an outer circumference. The independent air chamber design reinforces structural integrity and stability, ensuring the tire maintains mobility and performance even if one or more chambers, or an entire layer, is punctured.

### II. BACKGROUND OF THE INVENTION

### 1. Field of the Invention

The present invention relates to a tire with internal chambers and, more particularly, to a tire that has internal and independent chambers.

### 2. Description of the Related Art

Several designs for tires have been designed in the past. None of them, however, include internal isolated air chambers.

Applicant believes that a related reference corresponds to U.S. Pat. No. 8,656,971 issued for a wheel and multi-chamber tire assembly. Applicant believes that another related reference corresponds to U.S. Pat. No. 7,316,252 issued for a modular tire. None of these references, however, teach of a tire with independent air chambers, wherein in one exemplary iteration of the present invention, the chambers are embodied in a honeycomb design for added strength.

Other documents describing the closest subject matter provide for a number of more or less complicated features that fail to solve the problem in an efficient and economical way. None of these patents suggest the novel features of the present invention.

### III. SUMMARY OF THE INVENTION

It is one of the objects of the present invention to provide a tire having multiple air chambers embedded within its cross-section, wherein each air chamber is independent from one another, thereby, allowing an effective performance of the tire even when one or multiple air chambers are punctured

It is another object of this invention to provide a tire with internal chambers that have a predetermined geometry that strengthens the tire.

It is yet another object of this invention to provide such a device that is inexpensive to implement and maintain while retaining its effectiveness.

Further objects of the invention will be brought out in the following part of the specification, wherein detailed description is for the purpose of fully disclosing the invention without placing limitations thereon.

### IV. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an operational view of the present invention 100.

FIG. 2 shows an isometric view of the present invention 10

FIG. 3-7 illustrates cross-sectional views from lines A-A of FIG. 2, according to multiple mutually exclusive exemplary embodiments of the present invention.

FIG. 8-9 is a representation of partially broken cross-sectional views of the tire assembly 20, showing the chamber assembly 40 in different variations of the present invention.

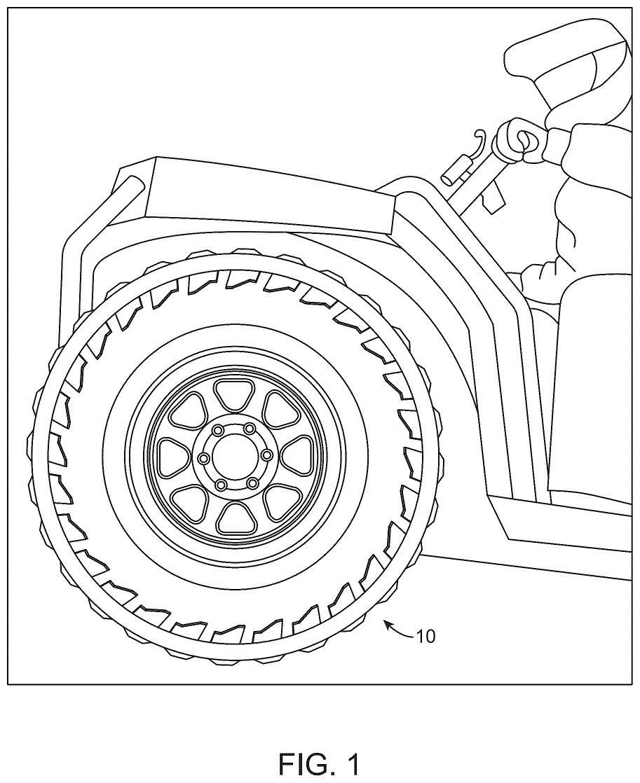

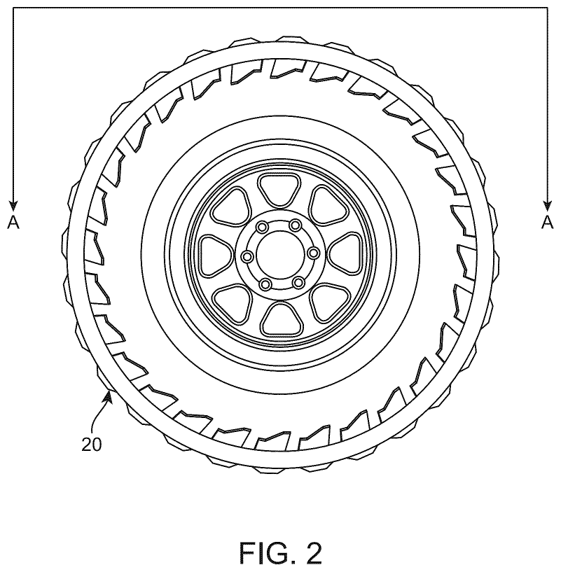

### V. DETAILED DESCRIPTION OF THE EMBODIMENTS OF THE INVENTION

Referring now to the drawings, where the present invention is generally referred to with numeral 10, it can be observed that it basically includes a tire assembly 20 and a chamber assembly 40. It should be understood there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Tire assembly 20 may include a tire formed by a tread, a sidewall, beads, a carcass, a belt, an inner liner, and other suitable elements that form tires as known in the art. The tread may be the part of the tire that makes contact with the road. Said tread is designed to provide traction and grip in various road conditions. Tire assembly 20 may enclose the chamber assembly 40. The tire assembly 20 may be removably attached to a rim. The tire assembly 20 may have an outer perimeter and an inner perimeter. Said outer perimeter may be greater than said inner perimeter.

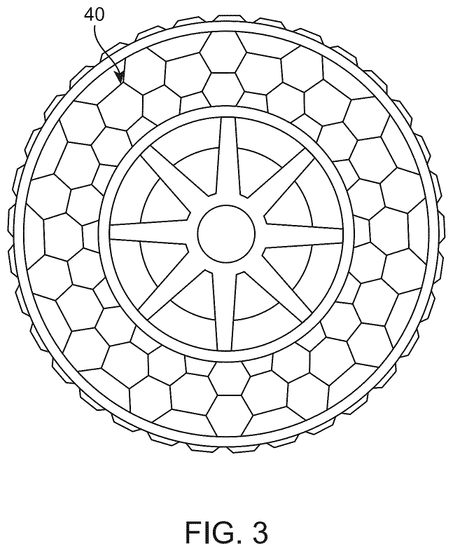

Chamber assembly 40 may include internal chambers 42 located in a predetermined arrangement within a cross-section of the tire assembly 20. The internal chambers 42 may be defined by walls 44 disposed in a cross-section of the tire. Said walls 44 define the structure of the chambers and isolate the air stored inside individual portions. Traditional tires include a valve stem that serves as a passage for inflating and deflating the tire. However, such a limitation is not suitable for the present invention, as stated above, the chambers 42 are isolated from one another; therefore, the present invention may need a valve stem for each chamber, which is not convenient; to address the aforementioned problem, the chamber assembly 40, in one exemplary embodiment, may be pre-inflated and may not include a valve stem to access individual chambers. In one exemplary embodiment, the chambers 42 may have a honeycomb arrangement, as depicted in exemplary FIG. 3. Honeycomb geometry refers to a structure that resembles a honeycomb in which hexagonal or other similar-shaped cells are arranged in a repeating pattern to create a rigid and strong structure. This type of geometry is often used in engineering and manufacturing applications, such as aerospace and construction, due to its high strength-to-weight ratio and ability to distribute loads evenly. In one exemplary embodiment, the air chamber disposed proximal to said outer perimeter may have a bigger area than the chambers disposed proximal to said inner perimeter. In one embodiment, coterminous chambers 42 may be independent from one another. The Chambers 42 are defined in concentric layers 45 extending radially from an outermost circumference of the inner cavity of the tire to an innermost circumference of the inner cavity, thereby defining a series of rows of said plurality of chambers 42.

The internal chambers 42 of the tire are delineated by internal walls 44 that fully occupy the interior space of the tire's structure. These walls 44 serve to demarcate and define the boundaries of the chambers 42, which occupy the space typically reserved for air or nitrogen in conventional tires. They exhibit diverse configurations, extending radially from the tire's center, traversing along the tire's circumference, or inclining at predetermined angles as exemplified in the figures. The thickness of the walls 44 may influence the chambers'performance. Thicker walls 44 generally contribute to increased structural integrity, potentially enhancing durability and resistance to external forces. Conversely, thinner walls 44 may reduce weight and improve flexibility, potentially enhancing maneuverability and fuel efficiency. Therefore, the wall thickness may be adjusted to achieve the desired balance between structural robustness and performance optimization.

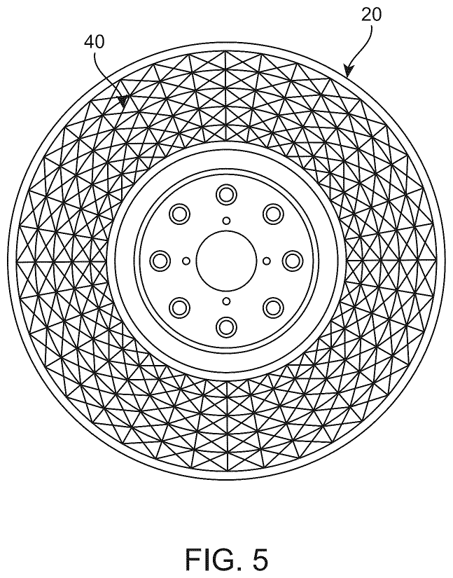

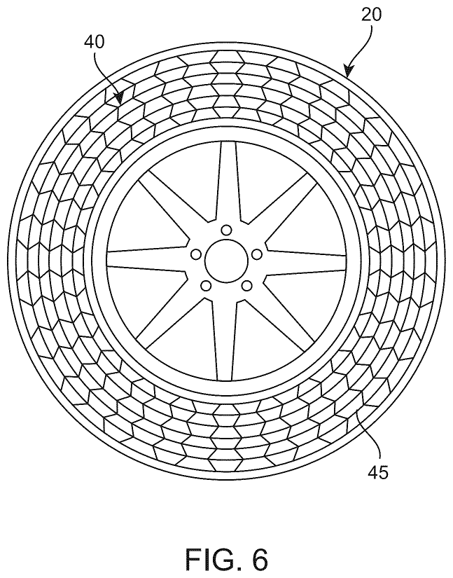

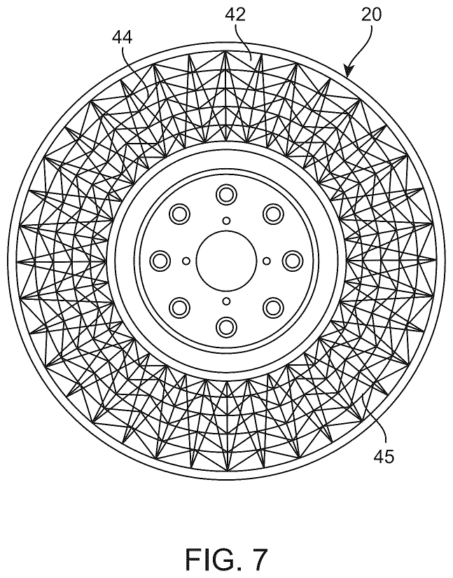

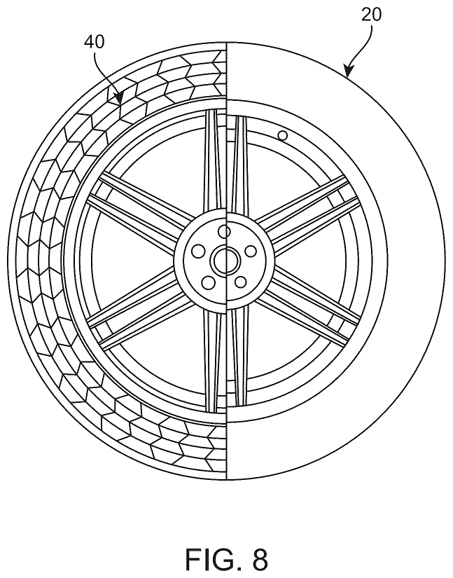

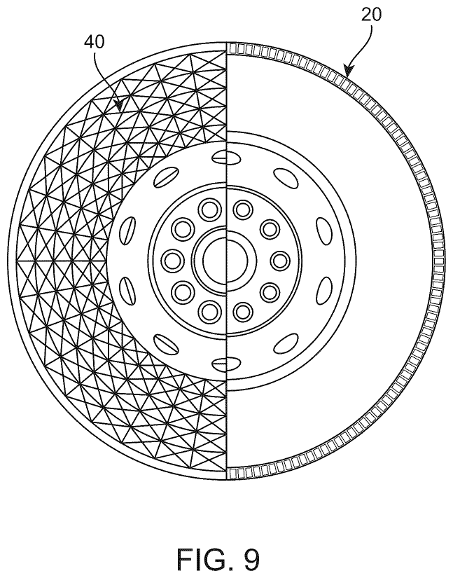

Exemplary embodiment of FIG. 7, show the chambers 42 of the chamber assembly 40 in a supplemental configuration, wherein the chambers 42 are presented in triangular shape. Triangular structures are commonly used for engineering projects because they offer several advantages over other shapes: triangles are inherently stable and can distribute weight evenly across their sides, making them strong enough to support heavy loads. Furthermore, triangular geometries can be used to create lightweight structures with a high strength-to-weight ratio. It should be noted that the shape of the chambers may be combined so that internally, the tire may have chambers of different shapes. In different exemplary embodiments (not shown in the drawings), the chambers may be formed in various regular/irregular shapes as showcased in exemplary FIG. 3-9. The chambers 42 may be filled with air or nitrogen. There are several studies in the state of art showing the benefits of different structures, case dependent, that can be assessed and applied to the present invention.

Be it, for exemplary purposes, that during operation, a foreign object perforates the tire and reaches one of the chambers causing it to deflate, in such a case, the tire will keep an effective performance as the adjacent chambers won't be affected by the deflated one. In such cases, a flat tire repair kit as widely known in the art, may be used to seal the punctured chamber. In another embodiment a handheld air pump may be used to both inflate the punctured chamber and seal it.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

### VI. INDUSTRIAL APPLICABILITY

The tire with internal chambers has multiple embodiments for industrial applicability. For instance, the invention can be used in passenger vehicle tires, commercial truck tires, aircraft tires, and other transportation applications where tire punctures and blowouts pose safety risks and operational disruptions. By having independent air chambers, a puncture only deflates the affected chamber(s) while the remaining chambers stay inflated, allowing the tire to retain mobility until it can be repaired or replaced. This improves vehicle safety and reduces downtime from tire failures.

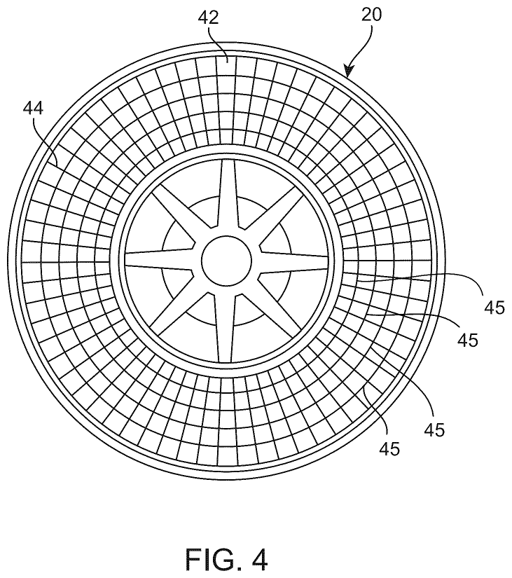

The predetermined geometries such as the ones illustrated throughout FIG. 4-10 (e.g., honeycomb or triangular shapes) for the internal chambers provide additional structural reinforcement, improving the tire's resistance to impacts and enhancing its load-bearing capacity. This can lead to longer tire life and better performance, benefiting industrial and commercial transportation.

The pre-inflated internal chamber design eliminates the need for individual valve stems on each chamber, simplifying manufacturing while still allowing punctured chambers to be re-inflated externally if needed. This economical design can reduce production costs compared to traditional tube-reinforced tires.

The tire with isolated internal chambers offers compelling advantages in industrial sectors like trucking, aviation, mining, and construction where preventing dangerous blowouts, reducing vehicle downtime, and extending tire life are paramount concerns. The invention's innovative chambered architecture provides a practical and robust solution.

What is claimed is:

1. A tire comprising:
an inner cavity structure, the inner cavity has a circumference;
a plurality of independent chambers defining the inner cavity structure, wherein each chamber is isolated from the other chambers by internal walls, wherein each chamber is pre-inflated with air or nitrogen, the plurality of chambers extend throughout said circumference; and
wherein the plurality of independent chambers are arranged in concentric layers extending radially from an outermost circumference of the inner cavity to an innermost circumference of the inner cavity, thereby defining a series of rows of said plurality of chambers.

2. The tire of claim 1, wherein the internal walls delineate and define the boundaries of the air chambers within the outer tire structure.

3. The tire of claim 1, wherein the internal walls extend radially from a center of the tire.

4. The tire of claim 1, wherein the internal walls traverse along a circumference of the tire.

5. The tire of claim 1, wherein the internal walls are inclined at predetermined angles within the outer tire structure.

6. The tire of claim 1, wherein a thickness of the internal walls is optimized for balancing structural integrity and weight.

7. The tire of claim 1, further comprising a sealing mechanism configured for sealing a punctured air chamber.

8. The tire of claim 7, wherein the sealing mechanism comprises a flat tire repair kit.

9. The tire of claim 7, wherein the sealing mechanism comprises a handheld air pump for re-inflating and sealing the punctured air chamber.

10. The tire of claim 1, wherein the plurality of independent air chambers provide structural reinforcement to the outer tire structure.

11. The tire of claim 1, wherein the outer tire structure comprises a tread, a sidewall, beads, a carcass, a belt, and an inner liner.

12. The tire of claim 1, wherein an outer perimeter of the outer tire structure is greater than an inner perimeter of the outer tire structure.

13. A tire consisting of:
an inner cavity structure, the inner cavity has a circumference;
a plurality of independent air chambers formed within the inner cavity structure, wherein each air chamber is isolated from the other air chambers by internal walls extending radially from a center of the tire to an outer circumference of the tire;
wherein an outer perimeter of the outer tire structure is greater than an inner perimeter of the outer tire structure;
wherein each chamber is pre-inflated with air or nitrogen, the plurality of chambers extend throughout said circumference; and
wherein the plurality of independent chambers are arranged in concentric layers extending radially from an outermost circumference of the inner cavity to an innermost circumference of the inner cavity, thereby defining a series of rows of said plurality of chambers

14. The tire of claim 13 , wherein the internal walls are inclined at predetermined angles within the outer tire structure.

15. The tire of claim 13, further comprising a sealing mechanism configured for sealing a punctured air chamber, wherein the sealing mechanism comprises a flat tire repair kit or a handheld air pump for re-inflating and sealing the punctured air chamber.
